(19) United States
(12) Patent Application Publication
(10) Pub. No.: US 2007/0082299 A1
(43) Pub. Date: Apr. 12, 2007

(54) Methods and apparatus for fabricating conductive features on glass substrates used in liquid crystal displays

(75) Inventor: Jeffrey Marks, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: Lam Research Corp., Fremont, CA (US)

(21) Appl. No.: 11/398,254

(22) Filed: Apr. 4, 2006

Related U.S. Application Data
(60) Provisional application No. 60/725,996, filed on Oct. 11, 2005.

(51) Int. Cl. G03C 5/00

(52) U.S. Cl. 430/321

(57) ABSTRACT

Methods and systems for defining metal features to be part of a liquid crystal display (LCD) is provided. The method is applied to a glass substrate, and the glass substrate has a blanket conductive metal layer (e.g., a barrier layer) defined on the glass substrate or a layer of the glass substrate. An inverse photoresist mask is applied over the blanket conductive metal layer. A plating meniscus is then formed over the inverse photoresist mask. The plating meniscus contains at least an electrolytic solution and a plating chemistry, where the plating meniscus forms metal features in regions over the blanket conductive metal layer not covered by the inverse photoresist mask.

### CLAIM OF PRIORITY

This Application claims priority to U.S. Provisional Patent Application No. 60/725,996, filed on Oct. 11, 2005, and is herein incorporated by reference in its entirety.

### CROSS REFERENCE To RELATED APPLICATION

This application is related to: (1) U.S. patent application Ser. No. 10/607,611 filed on Jun. 27, 2003 and entitled “APPARATUS AND METHOD FOR DEPOSITING AND PLANARIZING THIN FILMS OF SEMICONDUCTOR WAFERS,” (2) U.S. patent application Ser. No. 10/879,396 filed on Jun. 28, 2004 and entitled “ELECTROPLATING HEAD AND METHOD FOR OPERATING THE SAME,” (3) U.S. patent application Ser. No. 10/879,263 filed on Jun. 28, 2004 and entitled “METHOD AND APPARATUS FOR PLATING SEMICONDUCTOR WAFERS,” (4) U.S. patent application Ser. No. 10/882,712 filed on Jun. 30, 2004 and entitled “APPARATUS AND METHOD FOR PLATING SEMICONDUCTOR WAFERS;” AND (5) U.S. patent application Ser. No. 11/014,527 filed on Dec. 15, 2004 and entitled “WAFER SUPPORT APPARATUS FOR ELECTROPLATING PROCESS AND METHOD FOR USING THE SAME.” Each of the above noted applications is herein incorporated by reference.

### FIELD OF THE INVENTION

The present invention relates to the manufacture of metallization features in liquid crystal display (LCD) applications.

### BACKGROUND

Electroplating is a well-established deposition technology. In the semiconductor fabrication arts, electroplating is typically performed in a single-wafer processor, with the wafer immersed in an electrolyte. During electroplating, the wafer is typically held in a wafer holder, at a negative, or ground potential, with respect to a positively charged plate (also immersed in the electrolyte) which acts as an anode. To form a copper layer, for example, the electrolyte is typically between about 0.3M and about 0.85M CuSO₄, pH between about 0 and about 2 (adjusted by H2SO4), with trace levels (in ppm concentrations) of proprietary organic additives as well as Cl⁻ to enhance the deposit quality. During the plating process the wafer is typically rotated to facilitate uniform plating. After a sufficient film thickness has been achieved during the plating process, the wafer is moved from the plating chamber to another chamber where it is rinsed in deionized (DI) water, to remove residual electrolyte from the wafer surface. Next the wafer is subjected to additional wet processing, to remove unwanted copper from the backside and bevel edge, and then another DI water rinse removes wet processing chemical residues. Then the wafer is dried and annealed before it is ready for the chemical mechanical planarization (CMP) operation.

Although wet plating processes are commonly used in semiconductor wafer fabrication, to date, wet plating has not been used in LCD manufacturing. This is primarily due to the size of typical LCDs used in the manufacturing. For example, some LCDs are manufactured from glass substrates ranging is sizes of 3 meters by 3 meters. The large size makes plating, in the traditional sense, impractical due to severe non-uniformities that would be created throughout the surface regions. Secondly, copper plating is not practical because CMP operations would not work on such a large substrate. For these reasons, LCD metal features are restricted to sputtered aluminum features which are then etched to define the desired layout. A drawback to this current process is also the size of the glass substrate. A 3 meter by 3 meter substrate, to be sputtered substantially evenly, will require a very large source target (e.g., an aluminum target of about the same size as the substrate). The cost of the target can be substantial, however, a large target is needed to perform the aluminum sputtering.

In view of the foregoing, there is a need for methods and apparatus that will enable more efficient metal feature manufacturing on glass substrates, such as those used in LCD applications.

### SUMMARY

Broadly speaking, the present invention defines methods and system that enable metal feature fabrication using localized electroplating, to define metal features in an LCD, which is defined on a glass substrate. It should be appreciated that the present invention can be implemented in numerous ways, including as a process, an apparatus, a system, a device or a method. Several inventive embodiments of the present invention are described below.

In one embodiment, a method for fabricating metal features on a glass substrate is disclosed. The method includes applying a photoresist layer over the glass substrate. Then, patterning a plurality of features on the photoresist layer to define an inverse photoresist mask. A plating fluid is then locally applied over the inverse photoresist mask, such that a plating material is formed in regions not covered by the inverse photoresist mask. In a later operation, the inverse photoresist mask is removed to define metal features in the regions not covered by the inverse photoresist mask.

In another embodiment, a system for defining metal features on a glass substrate is disclosed. The system includes a photolithography unit. The photolithography unit is configured to apply and define an inverse photoresist mask over a glass substrate or layers formed over the glass substrate. A proximity plating head is provided. The proximity plating head is configured to form a plating meniscus that is to be applied to the inverse photoresist mask. The plating meniscus contains at least an electrolytic solution and a plating chemistry. A photoresist remover is provided to remove the inverse photoresist mask, leaving metal features formed in regions not previously covered by the inverse photoresist mask.

In yet another embodiment, a method for defining metal features to be part of a liquid crystal display (LCD) is disclosed. The method is applied to a glass substrate, and the glass substrate has a blanket conductive metal layer (e.g., a barrier layer) defined on the glass substrate or a layer of the glass substrate. An inverse photoresist mask is applied over the blanket conductive metal layer. A plating meniscus is then formed over the inverse photoresist mask. The plating meniscus contains at least an electrolytic solution and a plating chemistry, where the plating meniscus forms metal features in regions over the blanket conductive metal layer not covered by the inverse photoresist mask.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a cross sectional view of a glass substrate having layers fabricated thereon.

FIGS. 2-7 illustrate example metal features, which can be fabricated using an inverse photoresist mask and localized plating process.

FIGS. 8A, 8B, 8C and 8D-1-2, illustrate example structures for facilitating localized plating on a substrate having an inverse photoresist mask.

FIG. 9 illustrates an example process flow, for fabricating metal features over an LCD substrate.

FIGS. 10-11 illustrate example process flows for fabricating layers of a TFT device to be used in an LCD.

FIG. 12 illustrates an example bottom gate TFT structure.

### DETAILED DESCRIPTION

An invention, for methods and apparatuses for fabricating metallization features on glass substrates used in the manufacturer of liquid crystal displays (LCDs) is disclosed. The methods implement a method of forming metallization features without the need for expensive metal sputtering (e.g., which use expensive and large metal targets). Due to the sheer size of modern LCDs, the manufacturer requires the fabrication of metallization features on glass substrates as large as three meters by three meters. Consequently, the large size requires specially designed metal sputtering chambers and expensive large metal targets (sometimes as large as the substrate). The methods of the present invention utilize an inverse photoresist mask and then localized metallization plating. The metallization will form within the photoresist mask to define the metallization features. The photoresist mask is then removed to define the desired metallization features.

In the following description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

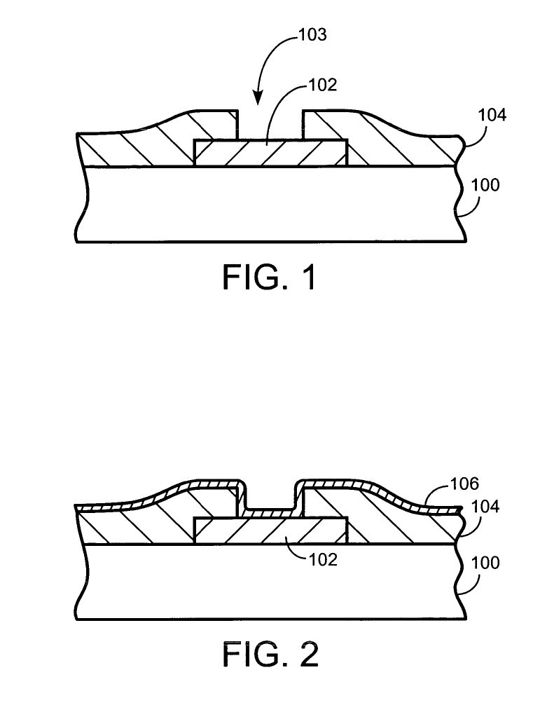

FIG. 1 illustrates a cross sectional view of a glass substrate 100 having layers fabricated thereon. The layers fabricated on glass substrate 100 are those that are commonly made when fabricating a liquid crystal display that consists of a plurality of thin film transistors (TFT). Therefore, the illustrated diagrams of FIGS. 1 through 7 illustrate exemplary process operations that are performed when fabricating a TFT on a glass substrate 100. However, the teachings of the present invention are equally applicable to the fabrication of any metallization structure on a glass substrate, such as those used in the manufacturer of LCDs. Example TFTs may be those referred to as Top Gate TFT, Bottom Gate TFT, and others. The geometric arrangements of each of these TFT devices vary in their specific ways, however, each utilize metallization features, and these features can be formed in accordance with the teachings of the present invention.

Referring to FIG. 1 again, the glass substrate 100 shows an amorphous silicon feature 102 which has been patterned thereon. As is well known, the amorphous silicon feature 102 is formed by first depositing an amorphous silicon layer. Although the amorphous silicon feature 102 is shown formed over the glass substrate 100, it will be appreciated by those skilled in the art of LCD manufacturing that other films, layers or features may well be fabricated over the glass substrate 100 before the amorphous silicon layer is formed. Thus, the shown structures in which the amorphous silicon is formed over the glass substrate 100 is simply an example. Continuing with the example, the amorphous silicon is patterned (e.g., with a suitable etch process) such that a plurality of amorphous silicon features 102 are formed.

The amorphous silicon features 102 define the semiconducting material that enables the definition of a transistor, such as the TFT. Amorphous silicon is commonly used because it is amenable to large area fabrication using glass substrates in a low temperature process, typically about 300 degrees C. to about 400 degrees C. Typically, an array of TFTs are formed throughout the glass substrate 100, such that a pixelized screen can be defined. Once the amorphous silicon feature 102 is formed, a dielectric layer 104 is formed over the amorphous silicon feature 102. The dielectric layer 104 is a silicon nitride (SiN) dielectric layer. The dielectric layer 104 is then patterned such that contact holes 103 are formed exposing the amorphous silicon feature 102.

FIG. 2 illustrates the cross sectional view of FIG. 1 after a barrier layer 106 is formed over the dielectric layer 104 and the exposed regions of the amorphous silicon feature 102. The barrier layer 106 may be a tantalum nitride (TaN) material or a nickel (Ni) material. The barrier layer is preferably in the thickness range of about 25 angstroms to about 200 angstroms, and more preferably between about 50 angstroms and about 150 angstroms. The barrier layer 106 should provide a conductive layer over the entire surface that is exposed at this processing step. By forming the barrier layer 106 over the entire surface, a conductive path will be defined for a localized plating operation, which will be discussed below.

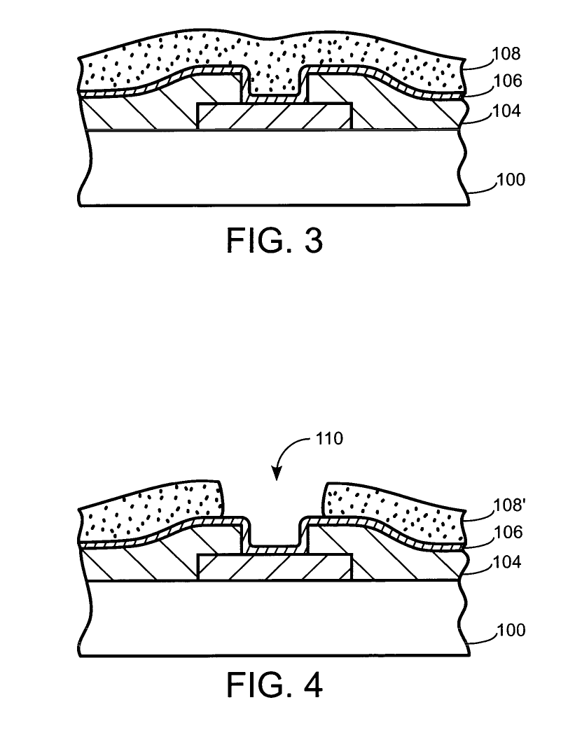

FIG. 3 shows the cross section of FIG. 2 after a photoresist layer 108 is formed over the barrier layer 106. The photoresist layer 108 is formed to a thickness that will control the ultimate thickness of the metal patterns that will be formed within patterned regions of the photoresist layer 108. In one embodiment, the photoresist layer 108 is patterned as shown in FIG. 4 such that exposed regions will define where metallization will ultimately reside. The patterned photoresist layer 108′ of FIG. 4 defines metal pattern regions 110 where a metallization will be plated. In this embodiment, the thickness of the photoresist layer 108 will define the thickness of the metallization feature. For instance, the thickness of the patterned photoresist 108′ is approximately in the order of 1 micron (e.g., 10,000 angstroms). Thus, the thickness of the photoresist 108′ is configured to control the desired thickness of the metallization lines that ultimately will be formed in the regions where the photoresist material was removed. The patterned photoresist layer 108′ defines an inverse photoresist mask.

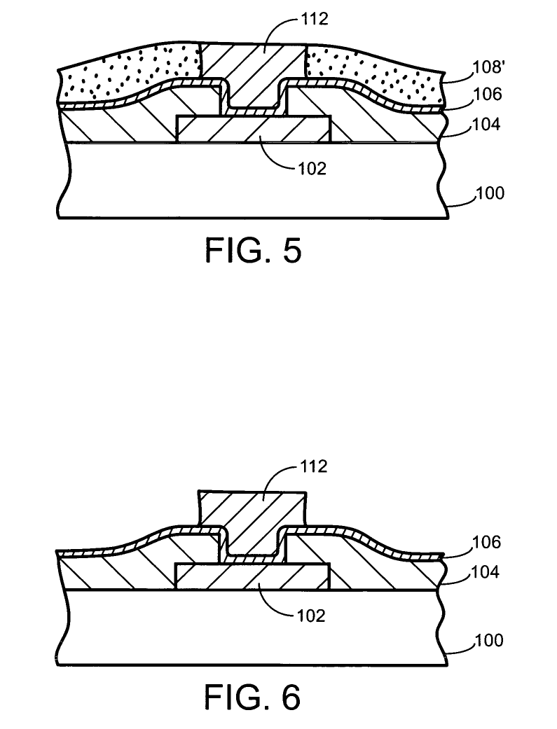

FIG. 5 illustrates a resulting metal pattern 112 that was plated within the patterned photoresist 108′. As will be discussed below, the metal pattern 112 is formed by a plating process that locally scans a plating material over the surface of the patterned photoresist 108 such that plating occurs only in regions where the photoresist material is not present and there is contact with the underlying barrier layer 106.

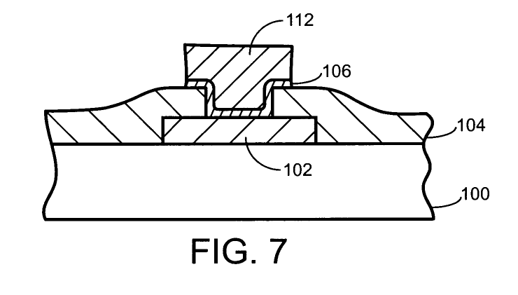

In a next step, the patterned photoresist 108′ is removed, as shown in FIG. 6 and then the barrier layer 106 is removed in FIG. 7. The resulting structure is a metallization feature 112 that was formed by simply plating within a patterned photoresist layer, where the patterned photoresist layer 108′ defines a thickness, shape and locations for the metal pattern 112. In this example, the metal pattern 112 defines the conductive gate that is making contact with the amorphous silicon pattern 102 through the dielectric 104. As mentioned above, the amorphous silicon feature 102 may be used to define a TFT in a liquid crystal display (LCD).

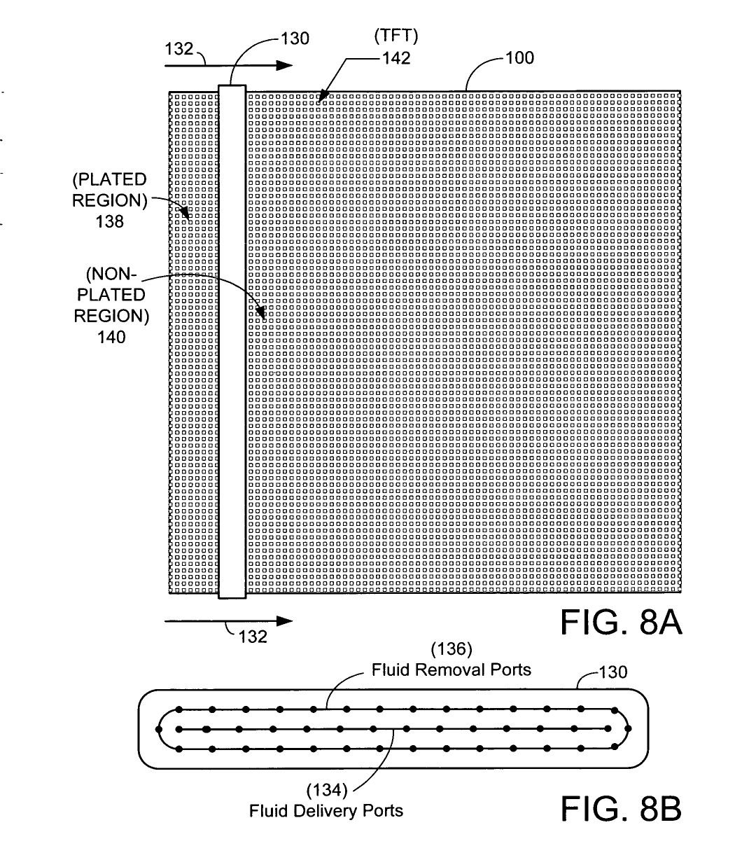

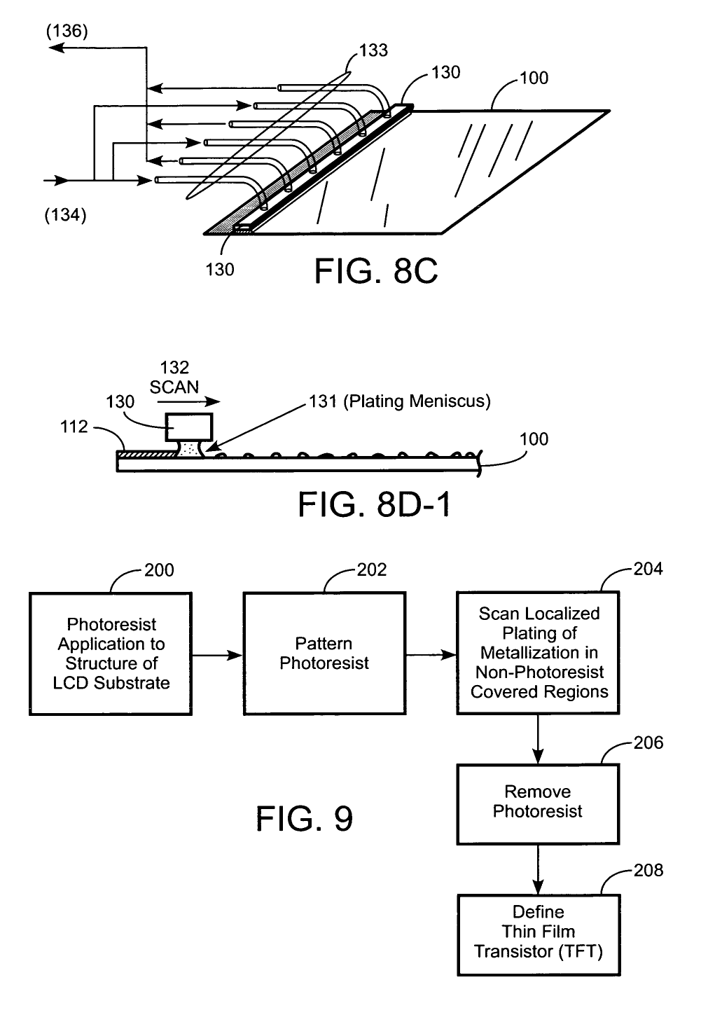

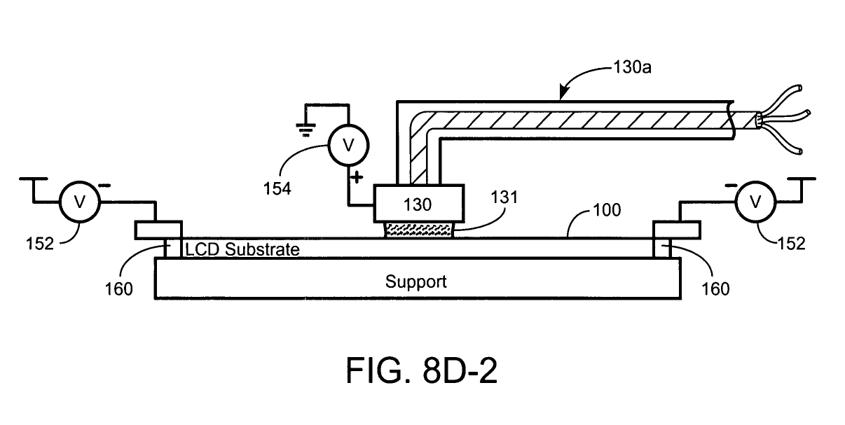

FIG. 8A illustrates a top view of a glass substrate 100. The top view of the glass substrate 100 shows a plurality of TFTs 142 formed throughout the glass substrate 100. In today's sizes, the glass substrate 100 may be in the range of about 3 meters by 3 meters. If smaller displays are needed, the display screens are formed by cutting the large fabricated 3 meter by 3 meter substrate into smaller panels. Although the size of the glass substrate 100 is large and may continue to grow, a proximity plating head 130 is configured to perform a plating process that is controlled over a localized plating region underneath the plating head. As illustrated, the proximity plating head is designed to scan in a scan direction 132 over the surface of the glass substrate 100.

The scanning of the proximity head 130 will define a plated region 138 over which the plating has occurred, and a non-plated region 140 defining a region that will be plated when the proximity head 130 scans in that direction 132. In one embodiment, to enable the scanning, the proximity head 130 can be designed to move, or the glass substrate 100 can be designed to move, or both can move. As mentioned above, the proximity head 130 is designed to plate specific local regions of the processed glass substrate 100 such that regions that are not covered by the photoresist are plated to a level that fills the defined patterned voids of the photoresist material 108′. Thus, the plated region 138 defines those plated areas that were defined by the patterned photoresist 108′ of FIG. 4. In one embodiment, the proximity plating head 130 can be designed to any length that is appropriate to scan over the entire surface of the glass substrate 100. Thus, the actual size of the glass substrate 100 is not determinate of the ability of the proximity head 130 to scan and deliver localized plating. Although not shown, the proximity head 130 can also be shorter than the width of the glass substrate 100. In such a case, the proximity head 130 can be designed to raster scan the surface until the entire surface or those regions desired for plating are scanned.

As shown in FIG. 8B, the bottom side of the proximity plating head 130 will include a number of ports (holes or channels defined in the proximity plating head 130) that allow fluid to be delivered to the surface of the glass substrate 100 and form a plating meniscus. It should be noted, however, that the actual configuration of the ports can vary in number and geometric placement, so long as a plating meniscus can be formed. In one example, a plurality of fluid delivery ports 134 are defined at about a center region of the proximity plating head 130, and a plurality of fluid removal ports 136 are defined around the fluid delivery ports 134. Vacuum can be used to remove the fluid using the fluid removal ports 136. This arrangement will allow fluid that is designed to plate a metallization material between the patterned photoresist to be efficiently delivered to the surface of the glass substrate 100, and the removal of the excess plating fluid through the fluid removal ports 136. The proximity plating head 130 is therefore designed to form a controlled meniscus 131 (as shown in FIGS. 8D-1 and 8D-2).

FIG. 8C illustrates a 3-dimensional diagram of a glass substrate 100 where a proximity plating head 130 is scanning over layers that may be formed over the glass substrate 100. The proximity plating head 130 is designed with a plurality of conduits 133 that deliver fluids through the fluid delivery ports 134 and remove fluids through the fluid removal ports 136. The configuration of the number of conduits and the number of ports is dependent upon the geometric shape, length and size of the proximity plating head 130. Thus, the conduits 133 and the ports 134 and 136 are only exemplary to illustrate the functionality of delivering the fluid that is designed to plate a conductive material over exposed regions of a photoresist mask. A discussion of example plating fluid materials will be provided below.

FIG. 8D- 1 illustrates a cross sectional view of FIG. 8C where the proximity plating head 130 is scanning in a direction 132 over layers formed over the surface of the glass substrate 100. The proximity plating head 130 is designed to perform the plating by way of delivering a controlled plating meniscus 131. The plating meniscus 131 will leave a plated region 112 within the patterned photoresist 108′ that is formed. As mentioned above, the glass substrate 100 is designed with a plurality of features that are defining an array of TFTs throughout the surface of the glass substrate 100. The delivery of the plating meniscus 131 will ensure that the plating material is supplied over the patterned photoresist 108′ such that metal patterns 112 will remain within the patterned regions of the photoresist 108′. Also noted above, the metal will have a thickness level defined by the thickness of the photoresist layer 108. Of course, the patterned metal 112 can be approximately to the thickness of the photoresist 108 or a slight variation thereof, depending on the desired process conditions.

FIG. 8D-2 illustrates a cross sectional view of the LCD glass substrate 100 that is placed over a support. The support may be a ridged support, a flexible support or a support that includes a conveyor assembly for easy movement of the substrate through a manufacturing plant or manufacturing stage. For purposes of defining one example plating process, the support is configured such that the LCD glass substrate 100 is in connected to conductive contacts 160. The conductive contacts 160 are designed to make electrical contact with the barrier layer 106 that was blanket deposited over the surface of the dielectric layer 104. By ensuring that the conductive contacts are in electrical conduction with the barrier layer 106, which is blanket deposited over the entire surface of the glass substrate 100, the plating meniscus 131 (which is provided with a positive electrical source 154) will complete a conduction path needed to facilitate the plating process. The conductive contacts, in this example, are coupled to negative electrical sources 152.

The negative electrical sources 152 provide a negative bias power that charges the barrier layer 106 to function as a cathode. Electrical contact may be established in the form of single point contacts, a bar contact over length of the substrate, or a plurality of point contacts through the edge of the substrate.

A proximity plating head 130 is charged as an anode by a positive power of the positive electrical source 154. The proximity plating head 130 is suspended above the substrate by an arm 130a. The arm 130a can contain a conduit channel for holding one or more conduits for delivery and removal of fluids utilized in the electroplating operation. Of course, the conduit channel can be coupled to the proximity plating head 130 by any other suitable technique, such as strapped to the arm 130a, etc. In one embodiment, the arm 130a is part of system that facilitates movement of the proximity plating head 130 across the substrate.

Movement of the proximity plating head 130 can be programmed to scan the substrate in any number of ways. It should be appreciated that the system is exemplary, and that any other suitable type of configuration that would enable movement of the head(s) into close proximity to the substrate may be utilized.

As used herein, localized metallic/metallization plating is meant to define an area beneath the proximity plating head 130 where a metallic material is deposited. As shown in the drawings, the area beneath the proximity plating head 130 is less than the surface area of the substrate. Thus, localized metallic plating will occur only under the proximity head 102 at a given point in time. To accomplish more metallic plating over the surface of the substrate, the proximity plating head 130 will need to move over another surface area of the substrate.

A seed layer (not shown) over the barrier layer 106 is optional, however, some embodiments may benefit from having the seed layer formed thereon before an electroplating operation is performed. When copper is the material being plated, the seed layer is typically a thin layer of copper that may be sputtered or deposited using known techniques. Thereafter, a deposited metal layer (e.g., to form the metal pattern 112 of FIG. 5) is formed over the seed layer as the proximity plating head 130 proceeds over the local area. The deposited metal is formed by way of an electrochemical reaction facilitated by an electrolyte contained in a meniscus 131 that is defined between the proximity plating head 130 and the seed layer (or barrier layer 106).

The plating chemistry is supplied by way of the plurality of fluid delivery ports 134 that enable localized metallic plating beneath the proximity plating head 130. Plating chemistry may be designed for deposition of copper, however other plating chemistries may be substituted depending on the particular application (i.e., the type of metallic material needed). The plating chemistry could be defined by an aqueous solution for depositing metals, alloys, or composite metallic materials. In one embodiment, deposited metals can include, but not limited to, one of a copper material, a nickel material, a thallium material, a tantalum material, a titanium material, a tungsten material, a cobalt material, an alloy material, a composite metallic material, etc.

The plating chemistry is preferably confined in a meniscus 131 that is defined as a thin layer of fluid lying over the exposed seed layer (or barrier layer 106) not covered by the inverse photoresist mask. To further confine and define the meniscus 131, an isopropyl alcohol (IPA) vapor may be supplied by way of additional fluid delivery ports (not shown). The thickness of the meniscus 131 may vary based on the desired application. In one example, the thickness of the meniscus may range between about 0.1 mm and about 10 mm. Thus, the proximity plating head 130 is placed close to the substrate surface. As used herein, the term “close” defines a separation between the undersurface of the proximity plating head 130 and the surface of the substrate, and that separation should be sufficient to enable the formation of a fluid meniscus. A plurality of fluid removal ports 136 provide vacuum to remove the fluid byproducts of the plating reaction delivered by the plurality of fluid delivery ports 134.

In accordance with an aspect of the invention, the deposited plating material is formed by a chemical reaction taking place in an electrolyte supplied by the plurality of fluid delivery ports 134. Charging the proximity plating head 130 as an anode facilitates the chemical reaction. In one example, the proximity head is electrically coupled to a positive bias voltage supply. To enable the plating, a reduction of ions in the chemistry is performed at the exposed seed layer or barrier layer, which is charged as a cathode through the electrical contact to a negative bias power supply. The chemical reaction causes a metallic layer to be formed as a deposited layer within the inverse photoresist mask. Reaction byproducts and depleted reactant fluids are removed via the plurality of fluid removal ports 136.

FIG. 9 illustrates a flow diagram of the method operations used in the fabrication of metallization features of an LCD substrate. The method begins at operation 200, where a glass substrate (which may have previously fabricated layers) is covered with a photoresist of a given thickness that will define a target metallization thickness. The photoresist is pattern in operation 202. The patterns will define the shape, size and location of metallization features to be formed, thus defining an inverse photoresist mask. In operation 204, localized plating of a metallization is scanned over the surface of the patterned photoresist. The metallization will form within the exposed surfaces not covered by the photoresist to define the desired metal features. In operation 206, the photoresist is removed and then other steps are performed to define the TFTs in operation 208. If additional metal features are needed, the same inverse mask/localized plating can be implemented any number of times.

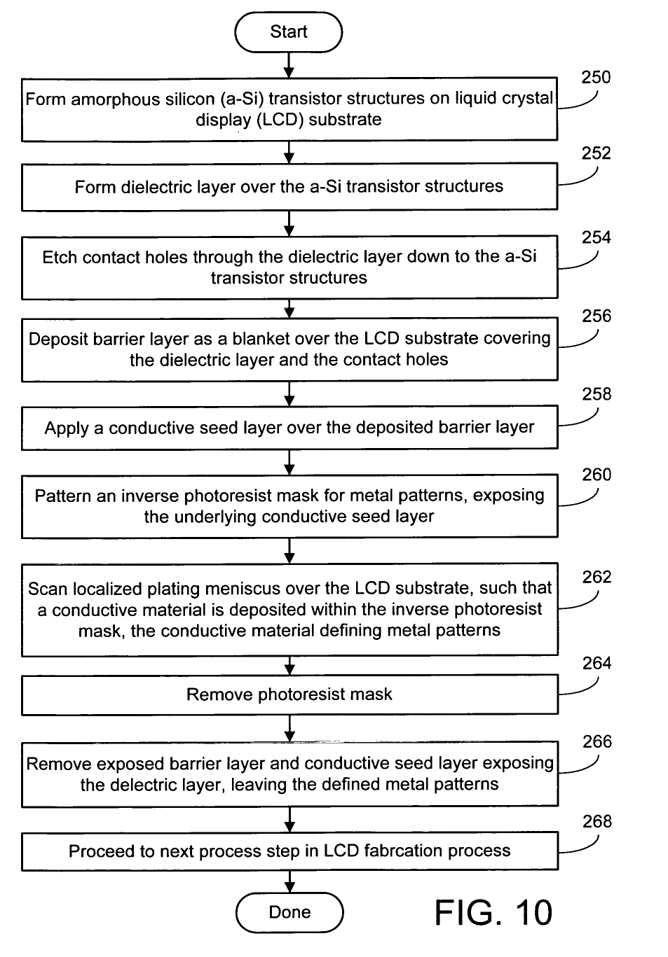

FIG. 10 illustrates a flowchart diagram of the process operations performed when defining metal patterns using a localized plating meniscus to form TFTs of a liquid crystal display, in accordance with one embodiment of the present invention. The method begins at operation 250 where amorphous silicon transistor structures are formed on a liquid crystal display substrate. As noted above, the amorphous silicon can be formed on fabricated layers that were previously defined on the glass substrate, depending on the type of TFT structure. The amorphous silicon transistor structures are defined throughout the liquid crystal display substrate to form an array of TFTs used in liquid crystal display technology.

In operation 252, a dielectric layer is formed over the amorphous silicon transistor structures 252, and then contact holes are etched through the dielectric layer down to the amorphous silicon structures in operation 254. A barrier layer is deposited as a blanket layer over the LCD substrate covering the dielectric layer and the exposed contact holes in operation 256. Next, a conductive seed layer is applied over the deposited barrier layer. In one embodiment, the conductive seed layer is a copper seed layer that is formed over the barrier layer which is typically a tantalum nitride layer (TaN). In operation 260, an inverse photoresist mask is patterned for defining metal patterns. The inverse photoresist mask will expose the underlying conductive seed layer.

In operation 260, a localized plating meniscus is scanned over the LCD substrate such that a conductive material is deposited within the inverse photoresist mask. The conductive material defines metal patterns. In one embodiment, the plating meniscus is designed to plate a copper layer which will then be in contact with the conductive copper seed layer formed in operation 258. As mentioned with respect to FIG. 8D-2, the localized plating meniscus is allowed to plate the copper material because a conductive path is formed between the positive electrical source 154 and the negative electrical source 152, that connects to the substrate (and the conductive barrier layer and seed layer). By creating this electrical path, it is possible to have the plating meniscus 131 plate the conductive material, e.g., copper in the regions not covered by the inverse photoresist mask.

In operation 264, the photoresist mask is removed. Any process for removing the photoresist mask can be used, including a wet photoresist removal process. In operation 266, the exposed barrier layer and the conductive seed layer are removed, exposing the dielectric layer and leaving the defined metal patterns. The operation can then proceed to a next step in the LCD fabrication process in operation 268.

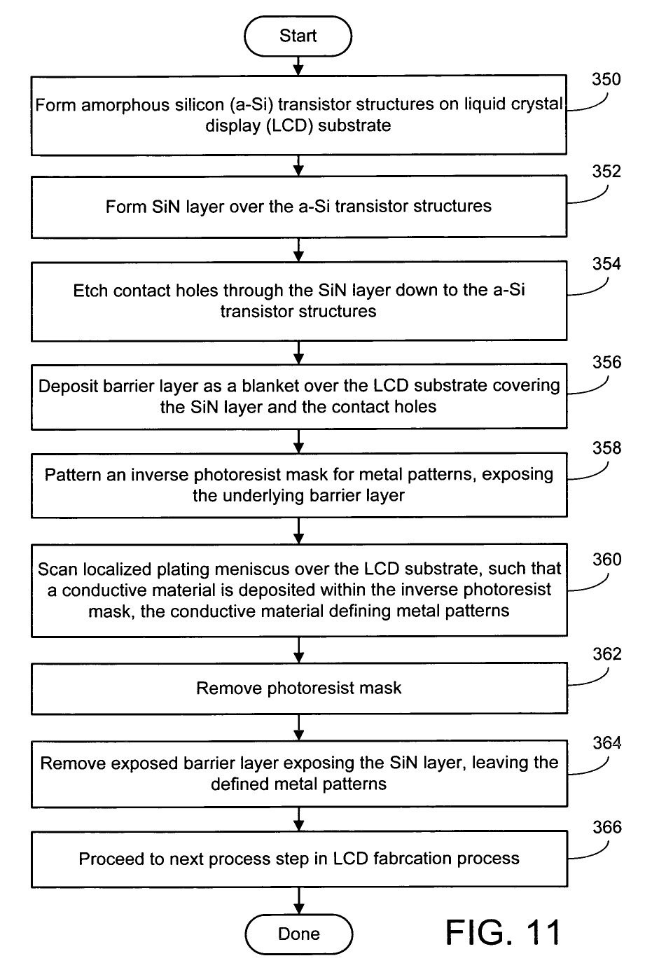

FIG. 11 illustrates a process operation for forming LCD TFT devices on an LCD substrate in operation 350. In operation 352, a silicon nitride (SiN) layer is formed over the amorphous silicon transistor structures that are defined throughout the LCD substrate. Contact holes are then etched through the silicon nitride layer down to the amorphous silicon structures in operation 354, and then a barrier layer is blanket deposited over the LCD substrate covering the silicon nitride layer and the contact holes in operation 356. In operation 358, an inverse photoresist mask is patterned for defining metal patterns. The inverse photoresist mask will therefore expose the underlying barrier layer in regions where it is desired to form metallization features.

In operation 360, a localized plating meniscus is scanned over the LCD substrate. A conductive material is then deposited using the localized plating meniscus within the inverse pattern mask. The conductive material will therefore define metal patterns. In operation 362, the photoresist mask is removed, and in operation 364, the barrier layer is removed exposing the silicon nitride layer and leaving the defined metal patterns. In operation 366, the process can then proceed to further operations for fabricating an LCD display.

It is notable to realize that the metallization patterns have been formed without the need to sputter a metallization material down and then performing an etch operation to defined the metal patterns, which is common in aluminum metal feature definition. Also, it is notable that chemical mechanical polishing (CMP) operations are not needed, which is common in copper feature definition in the semiconductor arts. A CMP procedure is not practical due to the size of glass substrates, and for this reason, traditional LCD fabrication uses expensive aluminum sputtering (with expensive large sputter targets) and etching. That is to say, copper features, although beneficial due to their properties, is not practical when CMP operations are needed to remove overburden material. Further, some etch operations are not practical in LCD fabrication, due to the elevated temperatures of some etchings operations. That is, elevated temperatures are not possible in LCD fabrication, as the glass substrate would not withstand some higher heat levels. For at least these reasons, the definition of localized plated features on large substrates is an advance in the art, which enables the fabrication of lower resistive copper metal lines (which can improve crystal switching speeds), without the need for expensive sputter chambers, CMP operations, expensive targets and elevated temperatures.

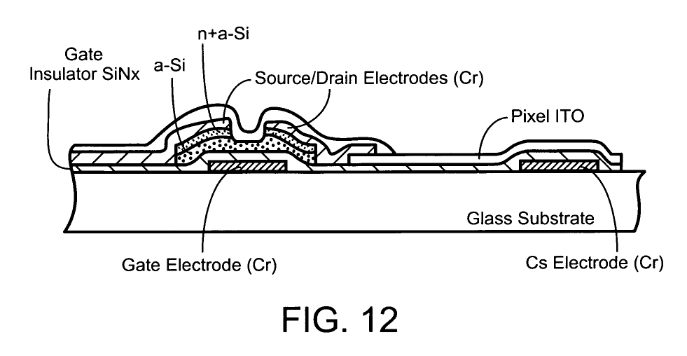

FIG. 12 illustrates an example bottom gate TFT structure. In this example, metal sputtering is used to define the gate electrodes and capacitor (Cs) electrodes. In accordance with one embodiment, the metal features are defined by first forming the inverse photoresist mask and then plating using the localized plating head. The source and drain electrodes can also be defined by first forming the inverse photoresist mask and then plating using the localized plating head. Accordingly, the actual structure shape or geometry is not a limitation of the invention disclosed herein. To the contrary, any shape, size or feature layout can be defined using an inverse photoresist mask and then plating using the localized plating head, as described above.

Example discussions of conventional TFT fabrication is discussed in U.S. Pat. No. 6,924,854, which issued on Aug. 2, 2005. This patent is herein incorporated by reference to illustrate example TFT structures, and in accordance with the claimed invention, the metal features can be defined using the inverse photoresist mask and plating using the localized plating head.

For additional information about top and bottom menisci, reference can be made to the exemplary meniscus, as disclosed in U.S. patent application Ser. No. 10/330,843, filed on Dec. 24, 2002, and entitled “MENISCUS, VACUUM, IPA VAPOR, DRYING MANIFOLD.” This U.S. patent application, which is assigned to Lam Research Corporation, the assignee of the subject application, is incorporated herein by reference.

For additional information about top and bottom menisci, vacuum, and IPA vapor, reference can be made to the exemplary system, as disclosed in U.S. patent application Ser. No. 10/330,897, filed on Dec. 24, 2002, and entitled “SYSTEM FOR SUBSTRATE PROCESSING WITH MENISCUS, VACUUM, IPA VAPOR, DRYING MANIFOLD.” This U.S. patent application, which is assigned to Lam Research Corporation, the assignee of the subject application, is incorporated herein by reference.

While this invention has been described in terms of several preferred embodiments, it will be appreciated that those skilled in the art upon reading the preceding specifications and studying the drawings will realize various alterations, additions, permutations and equivalents thereof. For instance, the electroplating system described herein may be utilized on any shape and size of substrates. It is therefore intended that the present invention includes all such alterations, additions, permutations, and equivalents as fall within the true spirit and scope of the claimed invention.

What is claimed is:

1. A method for fabricating metal features on a glass substrate, comprising:
applying a photoresist layer over the glass substrate;
patterning a plurality of features on the photoresist layer to define an inverse photoresist mask;
locally applying a plating fluid over the inverse photoresist mask, such that a plating material is formed in regions not covered by the inverse photoresist mask; and
removing the inverse photoresist mask to define metal features in the regions not covered by the inverse photoresist mask.

2. A method for fabricating metal features on a glass substrate as recited in claim 1, wherein the patterning of the plurality of features on the photoresist layer includes applying light to the photoresist in a photolithographic system.

3. A method for fabricating metal features on a glass substrate as recited in claim 1, wherein locally applying the plating fluid includes applying a plating meniscus to the inverse photoresist mask and the regions not covered by the inverse photoresist mask.

4. A method for fabricating metal features on a glass substrate as recited in claim 3, wherein the substrate includes a continuous conductive film, and the photoresist is applied over the continuous conductive film, such electrical contact is made to the continuous conductive film when the plating fluid is applied, wherein the plating meniscus is charged as an anode and the continuous conductive film is charged as a cathode, and plating occurs over the continuous conductive film in regions not covered by the inverse photoresist mask.

5. A method for fabricating metal features on a glass substrate as recited in claim 4, further comprising:
removing the continuous conductive film in regions that were previously covered by the inverse photoresist mask.

6. A method for fabricating metal features on a glass substrate as recited in claim 1, wherein the plating fluid is defined by one or more fluids and the fluids are selected from the group comprised of isopropyl alcohol (IPA), electrolytic solution, and a plating chemistry that enables metallic plating.

7. A method for fabricating metal features on a glass substrate as recited in claim 6, wherein the plating chemistry is defined by an aqueous solution for depositing metals including one of a copper material, a nickel material, a thallium material, a tantalum material, a titanium material, a tungsten material, a cobalt material, a chromium material, an alloy material, and a composite metallic material.

8. A system for defining metal features on a glass substrate, comprising:
a photolithography unit, the photolithography unit being configured to apply and define an inverse photoresist mask over a glass substrate or layers formed over the glass substrate;
a proximity plating head, the proximity plating head being configured to form a plating meniscus that is to be applied to the inverse photoresist mask, the plating meniscus containing at least an electrolytic solution and a plating chemistry; and
a photoresist remover, the photoresist remover being configured to remove the inverse photoresist mask, leaving metal features formed in regions not previously covered by the inverse photoresist mask.

9. A system for defining metal features on a glass substrate as recited in claim 8, wherein the a blanket conductive metal layer is defined over the glass substrate before the inverse photoresist mask is defined, such that the blanket conductive metal layer enables the proximity plating head to plate in regions not covered by the inverse photoresist mask and which expose the blanket conductive metal layer.

10. A system for defining metal features on a glass substrate as recited in claim 9, wherein the plating meniscus is charged as an anode and the blanket conductive metal layer is charged as a cathode to enable the plating.

11. A system for defining metal features on a glass substrate as recited in claim 8, wherein the plating chemistry is defined by an aqueous solution for depositing metals including one of a copper material, a nickel material, a thallium material, a tantalum material, a titanium material, a tungsten material, a cobalt material, a chromium material, an alloy material, and a composite metallic material.

12. A system for defining metal features on a glass substrate as recited in claim 8, wherein the metal features are part of a liquid crystal display structure.

13. A system for defining metal features on a glass substrate as recited in claim 12, wherein the liquid crystal display structure is a thin film transistor (TFT) structure.

14. A method for defining metal features to be part of a liquid crystal display (LCD), comprising:
on a glass substrate, the glass substrate having a blanket conductive metal layer defined on the glass substrate or a layer of the glass substrate;
applying an inverse photoresist mask over the blanket conductive metal layer;
forming a plating meniscus over the inverse photoresist mask, the plating meniscus containing at least an electrolytic solution and a plating chemistry, the plating meniscus forming metal features in regions over the blanket conductive metal layer not covered by the inverse photoresist mask.

15. A method for defining metal features to be part of a liquid crystal display (LCD) as recited in claim 14, further comprising:
removing the photoresist mask leaving metal features in regions not previously covered by the inverse photoresist mask.

16. A method for defining metal features to be part of a liquid crystal display (LCD) as recited in claim 14, wherein the plating meniscus is charged as an anode and the blanket conductive metal layer is charged as a cathode to enable the plating.

17. A method for defining metal features to be part of a liquid crystal display (LCD) as recited in claim 14, wherein the plating chemistry is defined by an aqueous solution for depositing metals including one of a copper material, a nickel material, a thallium material, a tantalum material, a titanium material, a tungsten material, a cobalt material, a chromium material, an alloy material, and a composite metallic material.
